(19) United States
(12) Patent Application Publication
(10) Pub. No.: US 2024/0213778 A1
(43) Pub. Date: Jun. 27, 2024

(54) SYSTEMS AND METHODS FOR AUTOMATED CORRECTION OF GIS DATA FOR LOADS AND DISTRIBUTED ENERGY RESOURCES IN SECONDARY DISTRIBUTION NETWORKS

(71) Applicants: Karen Montaño Martinez, Tempe, AZ (US); Vijay Vittal, Scottsdale, AZ (US); Shanshan Ma, Las Vegas, NV (US)

(72) Inventors: Karen Montaño Martinez, Tempe, AZ (US); Vijay Vittal, Scottsdale, AZ (US); Shanshan Ma, Las Vegas, NV (US)

(73) Assignee: Arizona Board of Regents on Behalf of Arizona State University, Tempe, AZ (US)

(21) Appl. No.: 18/393,040

(22) Filed: Dec. 21, 2023

Related U.S. Application Data
(60) Provisional application No. 63/435,014, filed on Dec. 23, 2022.

(51) Int. Cl. H02J 3/14

(52) U.S. Cl. CPC H02J 3/144

(57) ABSTRACT

A system for accurate secondary network topology geographic information system (GIS) coordinates correction provides a more accurate feeder topology for utilities to estimate and operate distribution systems by assigning the load and distributed energy resources (DER) nodes to their corresponding customer location. To simplify the complexity of the system, only two commonly available inputs are being used as input data: municipal parcel GIS delimitation data, and utility secondary feeder topology database. The system includes a three-stage framework: the first stage reads and processes the raw input data; the second stage works automatically with no human intervention to assign the load and DER nodes to their associated location; the third stage provides the load and DER coordinates and physical address.

### CROSS REFERENCE TO RELATED APPLICATIONS

This is a non-provisional application that claims benefit to U.S. Provisional Application Ser. No. 63/435,014, filed on Dec. 23, 2022, which is herein incorporated by reference in its entirety.

### GOVERNMENT SUPPORT

This invention was made with government support under DE-AR0001858 awarded by the Department of Energy. The government has certain rights in the invention.

### FIELD

The present disclosure generally relates to utility distribution, and in particular, to a system and associated method for automated correction of geographic information system data for loads and distributed energy resources in secondary distribution networks.

### BACKGROUND

Due to the recent emphasis on a more accurate representation of the electric distribution grid, several utilities now have extensive geographic information system (GIS) databases on distribution feeder equipment and conductor segments. These GIS databases have the ability to manage great amounts of geographical data constructed with spatial information obtained from expensive and labor-intensive manual work. By leveraging these GIS databases, more accurate distribution feeder models can be developed to address the needs of the utilities to improve distribution system modeling for future smart distribution systems. However, there are significant errors found in the GIS models of the secondary distribution circuits, which need to be resolved before using advanced power system GIS analysis strategies. At the same time, the continued increased number of distributed energy resources (DERs) and advanced metering infrastructure (AMI) placed in the secondary feeder, and data acquisition systems (DAS) placed in the distribution system can further complicate the secondary distribution feeder's GIS model generating more errors. Some of these errors in the GIS data include erroneous geographical location of elements, mismatched element parameters, and incorrect network connectivity. These errors impact the management, maintenance, response, and operation of the distribution system.

Many utilities are making efforts to reduce the errors in the GIS databases. These efforts include standard operating procedures to update changes associated to system assets in the field, as well as line inspection patrols to correct topology errors. However, little effort is being directed towards increasing the accuracy of the coordinate locations of elements such as loads and photovoltaic (PV) systems in the GIS databases. A correct set of coordinates for these elements is essential to obtain a more accurate representation of the secondary lines which connect the loads and distribution transformers as well as to correlate field measurements from AMI and DAS databases with their physical location in the feeder.

It is with these observations in mind, among others, that various aspects of the present disclosure were conceived and developed.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a simplified diagram showing an exemplary computing system for implementation of the systems outlined herein;

FIGS. 2A and 2B are a pair of simplified diagrams showing Correction of Secondary Topology Geographic Information System (GIS) Data according to a system and various methods outlined herein;

FIG. 3 is a simplified diagram showing Raw Input Data Processing according to the system and various methods outlined herein;

FIG. 4 is a simplified diagram showing a Density-Based Spatial Clustering of Applications with Noise (DBSCAN) method according to the system and various methods outlined herein;

FIG. 5 is an illustration showing parameter formulation for the DBSCAN method of FIG. 4;

FIG. 6 is a diagram showing a distribution system for study of the system and associated methods outlined herein;

FIG. 7 is a graphical representation showing load coordinate errors for a utility feeder topology database;

FIG. 8 is a graphical representation showing parcel errors for the utility feeder topology database of FIG. 7;

FIG. 9 is a diagram showing data processing stage results following application of the system and associated methods outlined herein;

FIG. 10 is a diagram showing load clustering preliminary results and final results following application of the system and associated methods outlined herein;

FIG. 11 is a diagram showing coordinate correction following application of the system and associated methods outlined herein;

FIG. 12 is a diagram showing coordinates that are outside associated premises prior to application of the system and associated methods outlined herein;

FIG. 13 is a diagram showing correction of nodes that do not belong to customers of the utility feeder by application of the system and associated methods outlined herein;

FIG. 14 is a graphical representation comparison between a physical address corresponding to corrected GIS coordinates and original GIS coordinates for the utility feeder topology database following application of the system and associated methods outlined herein;

FIG. 15 is a first diagram showing validation of the system and associated methods outlined herein with respect to a first case study dataset; and

FIG. 16 is a second diagram showing validation of the system and associated methods outlined herein with respect to a second case study dataset.

Corresponding reference characters indicate corresponding elements among the view of the drawings. The headings used in the figures do not limit the scope of the claims.

### DETAILED DESCRIPTION

A system and associated methods for automated secondary network topology construction are disclosed herein. The system provides an accurate distribution system topology by assigning loads and distributed energy resource (DER) nodes of a power distribution framework to their corresponding geographic customer locations. The system reads and processes raw data from the power distribution framework, and uses a nested clustering method paired with an optimization method to assign the loads and DER nodes to their corresponding customer parcel. In one aspect, the system can export a (“.csv”) file with meter locations represented by coordinates and their physical address.

In one aspect, the system provides a three-stage framework including a data processing stage, a topology construction stage, and an output stage. In a further aspect, the system uses a series of load clustering and optimization methods to correct geographic information system (GIS) coordinates of loads and DER nodes. In yet another aspect, the system uses commonly available inputs as input data to provide optimal locations for loads and DER nodes of the power distribution framework without requiring additional data collection.

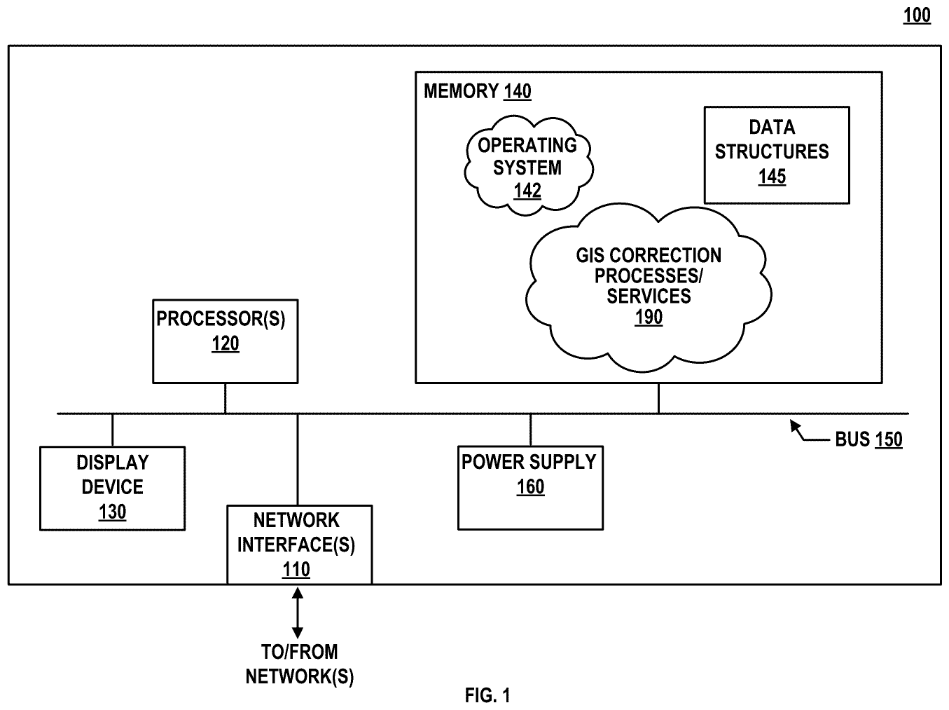

FIGS. 1-16 illustrate a computer-implemented system for secondary network topology correction of GIS data to provide a more accurate system topology by assigning load and DER nodes to their corresponding customer location. The system provides utilities with a more accurate feeder topology model and reduces the negative impacts caused by GIS model errors. To reduce the complexity and monetary/time cost of the system, the system can accept two commonly available inputs as input data, including:
municipal parcel GIS delimitation data for the location of the feeder (obtained from a municipal lot survey information, where a “parcel” can represent a geographic location covering an area); and
utility secondary feeder topology data (customers' billing information).

The present approach reads and processes the raw data, then uses a nested density-based spatial clustering (DBSC) method to cluster the load and DER nodes that correspond to the same customer to provide a single set of coordinates per customer. The procedure then uses an optimization method to assign the clusters to their corresponding customer parcel. The output of this system can include a comma-separated-value file (“.csv”) with meter locations in coordinates and their physical addresses.

This system allows a better correlation of loads and field measurements from AMI and DAS databases with their physical location in the secondary feeder. The system can be easily replicated and implemented at several utilities due to the simplicity of the input data and the limited human intervention needed. Other approaches use AMI measurements or image processing methods to achieve similar results. These methods often use data that is not often available for the utilities or to all their distribution systems. In contrast, the input data accepted by the system is commonly available and requires minimal human intervention to correct the GIS coordinates of loads and DERs in large feeder databases.

FIG. 1 is a schematic block diagram of an example device 100 that may be used with one or more embodiments described herein.

Device 100 comprises one or more network interfaces 110 (e.g., wired, wireless, PLC, etc.), at least one processor 120, and a memory 140 interconnected by a system bus 150, as well as a power supply 160 (e.g., battery, plug-in, etc.). Device 100 can include or otherwise communicate with a display device 130 that displays results of the optimizations and corrections applied by the systems outlined herein.

Network interface(s) 110 include the mechanical, electrical, and signaling circuitry for communicating data over the communication links coupled to a communication network. Network interfaces 110 are configured to transmit and/or receive data using a variety of different communication protocols. As illustrated, the box representing network interfaces 110 is shown for simplicity, and it is appreciated that such interfaces may represent different types of network connections such as wireless and wired (physical) connections. Network interfaces 110 are shown separately from power supply 160, however it is appreciated that the interfaces that support PLC protocols may communicate through power supply 160 and/or may be an integral component coupled to power supply 160.

Memory 140 includes a plurality of storage locations that are addressable by processor 120 and network interfaces 110 for storing software programs and data structures associated with the embodiments described herein. In some embodiments, device 100 may have limited memory or no memory (e.g., no memory for storage other than for programs/processes operating on the device and associated caches). Memory 140 can include instructions executable by the processor 120 that, when executed by the processor 120, cause the processor 120 to implement aspects of the system and the methods outlined herein.

Processor 120 comprises hardware elements or logic adapted to execute the software programs (e.g., instructions) and manipulate data structures 145. An operating system 142, portions of which are typically resident in memory 140 and executed by the processor, functionally organizes device 100 by, inter alia, invoking operations in support of software processes and/or services executing on the device. These software processes and/or services may include GIS Correction processes/services 190, which can include aspects of methods and/or implementations of various modules described herein including the nested DBSCAN methods discussed above. Note that while GIS Correction processes/services 190 is illustrated in centralized memory 140, alternative embodiments provide for the process to be operated within the network interfaces 110, such as a component of a MAC layer, and/or as part of a distributed computing network environment.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules or engines configured to operate in accordance with the techniques herein (e.g., according to the functionality of a similar process). In this context, the term module and engine may be interchangeable. In general, the term module or engine refers to model or an organization of interrelated software components/functions. Further, while the GIS Correction processes/services 190 is shown as a standalone process, those skilled in the art will appreciate that this process may be executed as a routine or module within other processes.

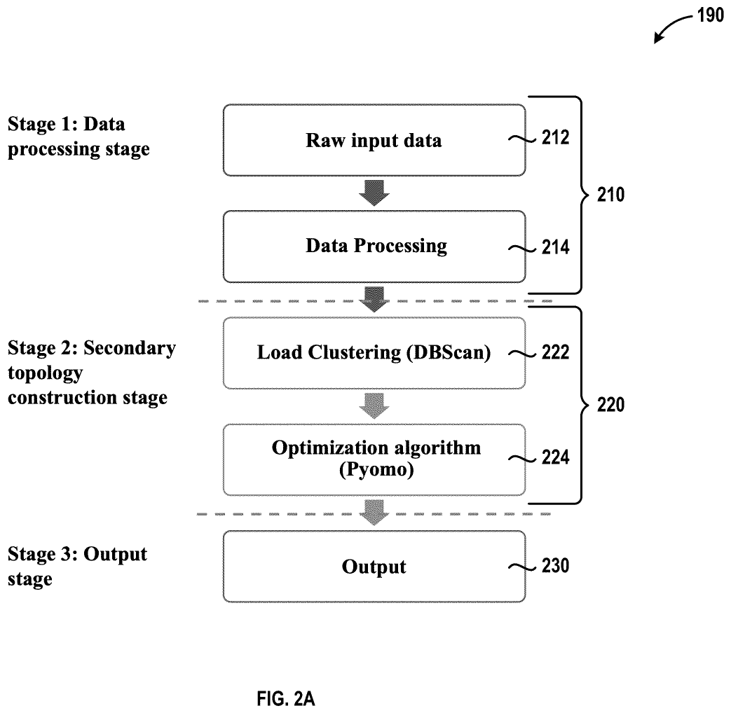

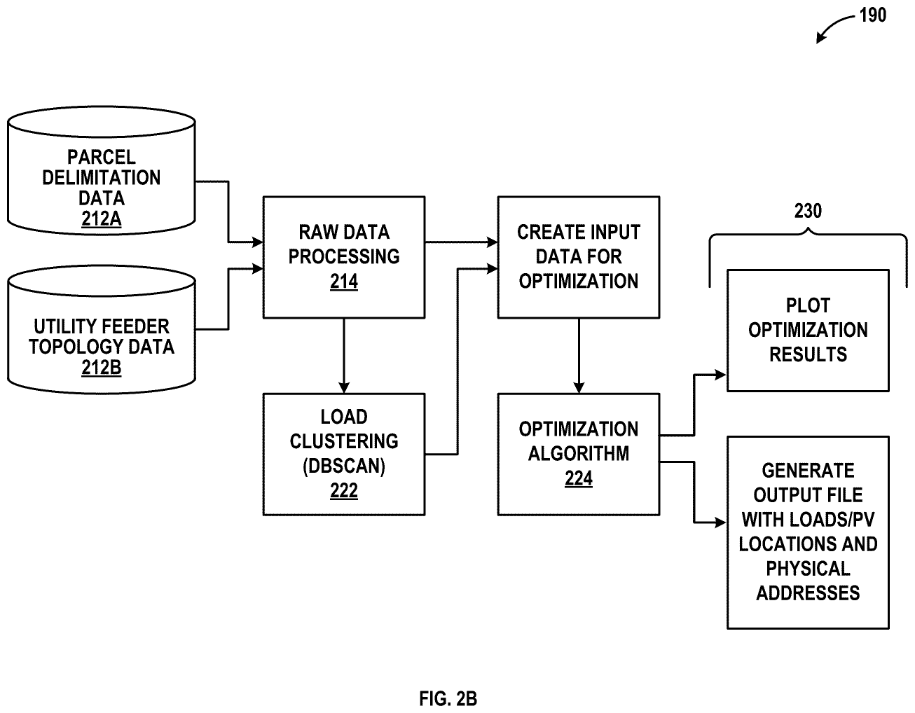

The GIS Correction processes/services 190 can determine a system topology by application of a three-stage process illustrated in FIGS. 2A and 2B.

### 1. Data Processing Stage:

At a first data processing stage 210, the system accepts raw input data 212 including municipal parcel GIS delimitation data 212A and data from a utility secondary feeder topology database 212B. For raw data processing 214, the system generates a plurality of shapefiles based on the input data 212 and extracts geometry information from the shapefiles including the coordinates of all elements in both databases. Then, the system automatically sets the same GIS system reference for the geometry information of the elements guaranteeing that the coordinates are at the same location. Next, using the coordinates from the parcel GIS delimitation data, the system creates polygons of the parcels and then calculates the centroid of the polygons for each parcel in the feeder. The system also performs an automated recognition of the load and DER nodes and populates a database with the coordinates for these subsets of nodes.

To simplify the complexity the system and to extend its generality, two commonly available inputs are used as input data 212:
1. Parcel GIS delimitation data 212A of the feeder. These data are usually available for entire counties around the country, and are considered accurate since they are used as geographical-reference data for tax purposes. Additionally, these databases are public, and include relevant parcel attributes such as physical address and size.
2. Utility secondary feeder topology data 212B. Usually, utilities have databases for their customers' location for billing purposes. These databases are frequently highly inaccurate in terms of location of load and photovoltaic (PV) nodes (coordinates). The location of these nodes are used as initial input for the tool proposed and will be corrected for errors when the processing is completed.

The input data 212 should be available in any GIS format as long as it could be translated to a shapefile format (filename extension “.shp”, “.shx”, “.dbf”), which is a vector data format for GIS software. This format describes vector features such as points, lines, and polygons, which represents the components of the database and usually contains other attributes.

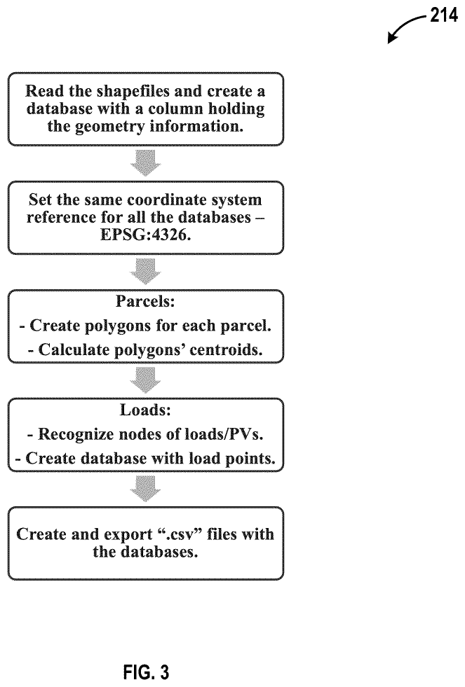

To obtain the information needed for the load clustering and optimization methods, the detailed raw input data processing procedure is shown in FIG. 3 is implemented. First, the geometry information which includes the coordinates of all the elements in both databases is retrieved from the shapefiles created from the input data. Then, the tool automatically sets the same GIS system reference for the geometry information of the elements guaranteeing that the coordinates are in the same location. Next, using the coordinates from the parcel GIS delimitation data, the tool creates polygons of the parcels and then calculates the centroid of the polygons for each parcel in the feeder. The tool also performs an automated recognition of the load and DER nodes and creates a database which include the coordinates for these subset of nodes.

### 2. Topology Construction Stage:

At a second topology construction stage 220, the system clusters the load and DER nodes that correspond to the same customer to provide a single set of coordinates per customer. In one aspect, this “clustering” can be applied by a “density-based spatial clustering of applications with noise” (DBSCAN) clustering method. Since the utility secondary feeder topology database corresponds to the billing information of the customers, the load and DER nodes are defined separately to keep track of customers with PV systems. The system then assigns the clusters to their corresponding premise; in one aspect, this can be accomplished by application of an optimization method developed in Pyomo.

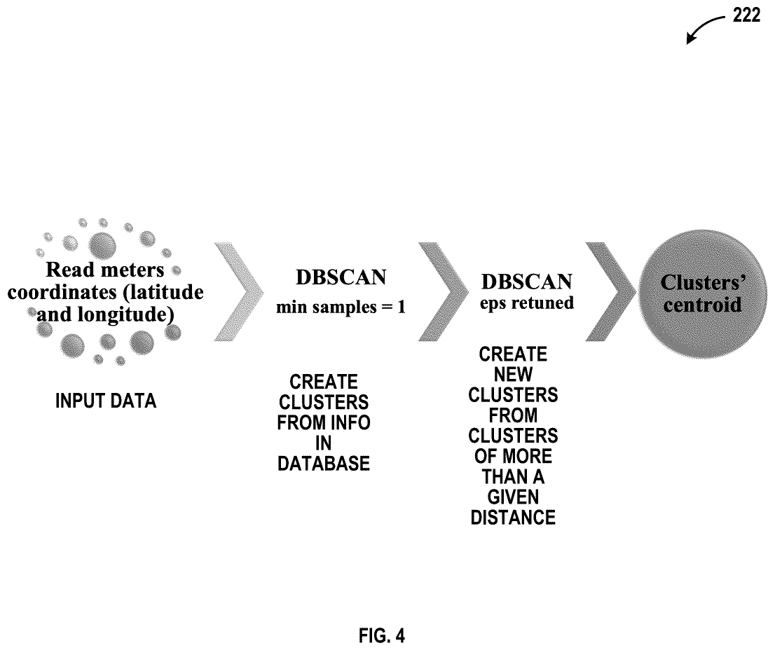

The first step of the second topology construction stage (load clustering stage 222 illustrated in FIGS. 2A, 2B and 4) uses a nested DBSCAN method to cluster the load and DER nodes corresponding to the same customer. The second step uses an optimization method (optimization algorithm 224 illustrated in FIGS. 2A and 2B) developed in Pyomo to assign these clusters to their corresponding premise and correct their coordinates accordingly. The methods used in both steps are formulated as follows:

### A. Load Clustering (DBSCAN Clustering)

The DBSCAN method is a density-based clustering method that discovers clusters of arbitrary shape—spherical, drawn-out, linear, and other similar shapes. This is especially useful compared to other clustering methods such as k-means which assumes that the clusters are convex shaped. To identify the clusters the DBSCAN starts with an arbitrary point p and clusters all the points that are density reachable from p using the parameters specified.

This method is efficient for large spatial databases and only requires two input parameters to be specified, minsamples and eps, which define the density of the clusters. The parameter minsamples controls the method's tolerance to noise by specifying the minimum number of points inside a cluster. The parameter eps controls the local neighborhood of the points and is a distance function. If this parameter is chosen too small, most data will not be clustered. If it is chosen too large, close clusters would merge into one cluster. Point p is considered a core point when there exist minsamples number of other points within a distance of eps, which are defined inside the same cluster as the point p. A point p is a border point when there are not minsamples points in its neighborhood, but it lies within eps distance from a core point. A noise point is a point that is not a core or border point.

Due to the efficiency of the method on large databases, its minimal requirements of knowledge to determine the input parameters (appropriate values are unknown in advance when dealing with large databases), and its ability to discover clusters with arbitrary shape, it is selected to cluster the customers' nodes to provide a single set of coordinates per household.

As mentioned, a “nested” DBSCAN method is implemented as shown in FIG. 4. This method reads the load coordinates exported from the data processing stage.

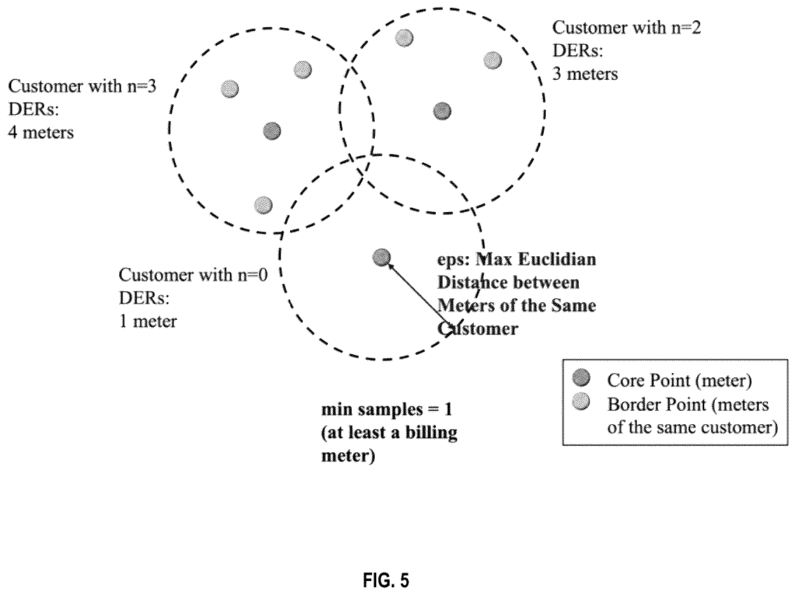

A formulation for the DBSCAN clustering method applied by the system is as follows:
1. Objective: Create clusters of nodes that correspond to the same customer and calculate the cluster's centroid.
2. Input Data: The coordinates of loads obtained from the data processing stage.
3. Constraints: The constraints are specific to the distribution feeder under study and are used to define the parameters of the method. Usually, the loads and DERs are defined in terms of nodes in the billing information database provided by the utilities. Each customer should have a load node, and can include none, one or n individual DERs. Therefore, the minimum number of points inside a cluster, that is, the parameter minsamples is set as 1 (load node). Similarly, the maximum number of meters per customer should be n+1 (load node plus DER nodes). The maximum Euclidian distance between points inside a cluster is needed to set the parameter eps. This distance is obtained by measuring the distances between meters of the same customer, and it should be set according to the feeder under study. FIG. 5 shows an example to illustrate the DBSCAN parameters for this formulation.
4. Unknown data: Total number of clusters (customers in the feeder).
5. Output: Coordinates (latitude and longitude) of the clusters' centroid.

As shown in FIG. 4, the first DBSCAN creates clusters from the utility database using minsamples=1 (at least one node per cluster). Since the DBSCAN method does not allow the setting of the maximum number of members of a cluster as a parameter, a second instance of the DBSCAN method is needed for all the clusters with more than n+1 elements (maximum n DER systems per customer). The second instance of the DBSCAN method is applied for each cluster with more than n+1 elements and for some clusters with less than or equal to n+1 elements, where the parameter eps is retuned. Each time the second instance of the DBSCAN method is applied creates new clusters from the grouped nodes. Then, the DBSCAN method calculates the centroid of the clusters as the geometrical center point which depends on the number of elements in the cluster.

### B. Optimization Method for Coordinates Correction

The optimization method at this stage takes as input data the coordinates of the parcels' centroids obtained from the data processing stage, and also takes the coordinates of the clusters' centroids from the DBSCAN method. Additionally, another input parameter can include the maximum distance Dₘₐₓ that a cluster/load should be from the parcels to be considered a customer load and not a streetlight or other type of load. In one example implementation, the optimization method is developed using Pyomo, and can be solved using Gurobi, CPLEX, or any other solver that supports convex problems.

At first, the optimization method calculates the distances D between the clusters and the parcels using the coordinates as:

$${D}_{i , j} = \sqrt{{( {x}_{j} - {x}_{i} )}^{2} + {( {y}_{j} - {y}_{i} )}^{2}} , ∀ i ∈ {Ω}_{cl} , ∀ j ∈ {Ω}_{p} \qquad ( 1 )$$

where Ω_{cl} are the clusters, and Ωₚ are the parcels from the parcel delimitation database.

Using Dₘₐₓ, the input data is filtered using the following rules:
1) If a load is at a farther distance than Dₘₐₓ from all the parcels' centroid, then this load is not considered customer load (e.g., where the load could be a streetlight, etc.). That is,

$${Ω}_{c l}^{p} = {Ω}_{c l} - {Ω}_{L} \qquad ( 2 )$$

where Ω_{L} is the set of bus nodes without customer loads (e.g., streetlights, etc.), and Ω_{cl}^{p} is the set of clusters to be considered by the optimization method as customer loads.
2) If a parcel is at a farther distance than Dₘₐₓ from all the clusters' centroids, then this parcel is not part of the considered feeder. That is,

$${Ω}_{p}^{c l} = {Ω}_{p} - {Ω}_{{p}_{o u t}} \qquad ( 3 )$$

where Ωₚ_{ₒᵤₜ} is the set of the premises not connected to the feeder under consideration, and Ωₚ^{cl} is the set of parcels connected to the feeder to be considered for load placement by the optimization method as a customer parcel.
3) If a distance D_{i,j} is lower than Dₘₐₓ for i∈Ω_{cl}^{p}, for j∈Ωₚ^{cl}, then the pair (i, j)∈Ω_{D}, where Ω_{D} are the possible connections between a cluster and a parcel. Using these rules, the objective function is defined to minimize the sum of the distances between the clusters Ω_{cl}^{p} and the premises Ωₚ^{cl}, and to maximize the quantity of clusters i∈Ω_{cl}^{p} assigned to the parcels j∈Ωₚ^{cl} for (i, j)∈Ω_{D}. Therefore, the objective function is formulated as shown in (4).

$$min {\sum }_{i ∈ {Ω}_{c l}^{p}} {\sum }_{j ∈ {Ω}_{p}^{c l}} {X}_{i , j} {D}_{i , j} + \vert {Ω}_{c l}^{p} \vert - {\sum }_{i ∈ {Ω}_{c l}^{p}} {\sum }_{j ∈ {Ω}_{p}^{c l}} {X}_{i , j} ∀ ( i , j ) ∈ {Ω}_{D} \qquad ( 4 )$$

where X_{i,j} is a binary variable that is 1 if a cluster i∈Ω_{cl}^{p} is assigned to a parcel j∈Ωₚ^{cl}. The variable X_{i,j} has the following constraints:
1) Only one parcel j∈Ωₚ^{cl} can be assigned to a cluster i∈Ω_{cl}^{p} (X_{i,j}=1) or to none (X_{i,j=}0) for a cluster that is farther than Dₘₐₓ.

$${\sum }_{j ∈ {Ω}_{c l}^{p}} {X}_{i , j} \leq 1 ∀ ( i , j ) ∈ {Ω}_{D} \qquad ( 5 )$$

2) Only one cluster (i∈Ω_{cl}^{p}) can be assigned to a parcel (j∈Ωₚ^{cl}) (X_{i,j}=1) or zero loads for empty parcels X_{i,j}=0).

$${\sum }_{i ∈ {Ω}_{p}^{c l}} {X}_{i , j} \leq 1 ∀ ( i , j ) ∈ {Ω}_{D} \qquad ( 6 )$$

After filtering the input data, the objective function applied minimizes the sum of the distances between the clusters and the premises, and to maximize the number of clusters assigned to the parcels.

### 3. Output Stage:

The output 230 of the system can include data indicative of the location of each node (load nodes and DER nodes) in terms of geographic coordinates, that is, the coordinates of the centroid of the parcel they were assigned to by the methods outlined herein, and their physical address, which can be obtained from the parcel GIS delimitation data. In one example implementation, the system can represent this data within a comma-separated-value (.csv) file. These data provide a more accurate set of coordinates for the GIS databases and can be used to construct the secondary network topology.

The processes applied by the system provide a simple and quick but highly accurate solution to a very complicated common problem for electric utilities. The system applies a nested clustering and optimization method to input data correct the coordinates of the loads and PVs, and then provides a (“.csv”) file with the output to be used to correct the GIS databases.

### 4. Utility Feeder Case Study

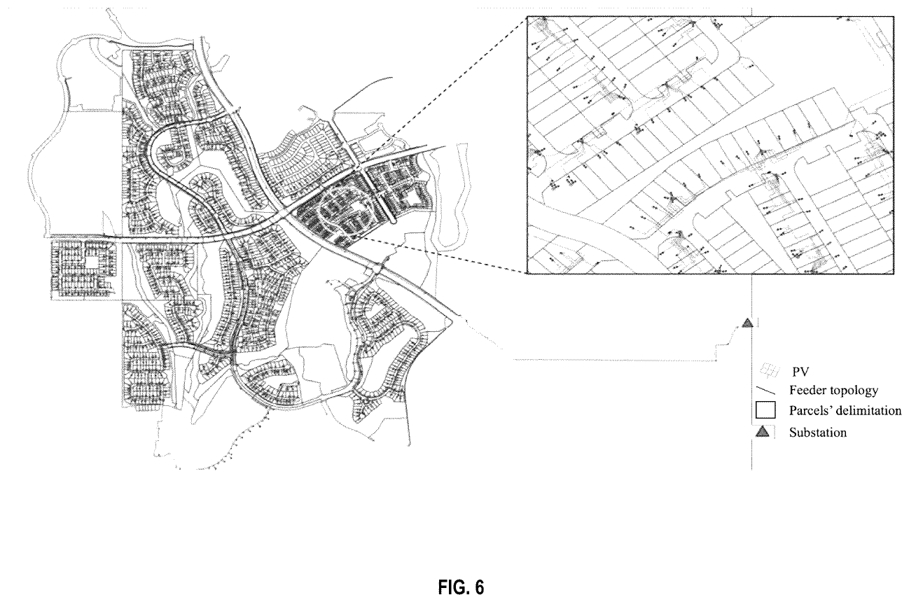

This section presents the case study used to implement the developed tool. The proposed method is tested on an actual 12.47 kV, 9 km-long utility feeder in Arizona that serves residential customers. This feeder has one of the highest PV penetrations among the utility's operational feeders, with a penetration level of more than 200% compared to the feeder total gross load observed during peak solar PV production hours. The database provided by the utility for this feeder has 11083 nodes where 1945 are load nodes (customer, street-lights, and other loads), and 751 are PV nodes. The feeder has 371 distribution transformers, and 4 capacitor banks. FIG. 6 shows the parcel GIS delimitation data obtained from the county, and the utility secondary feeder topology database for the feeder.

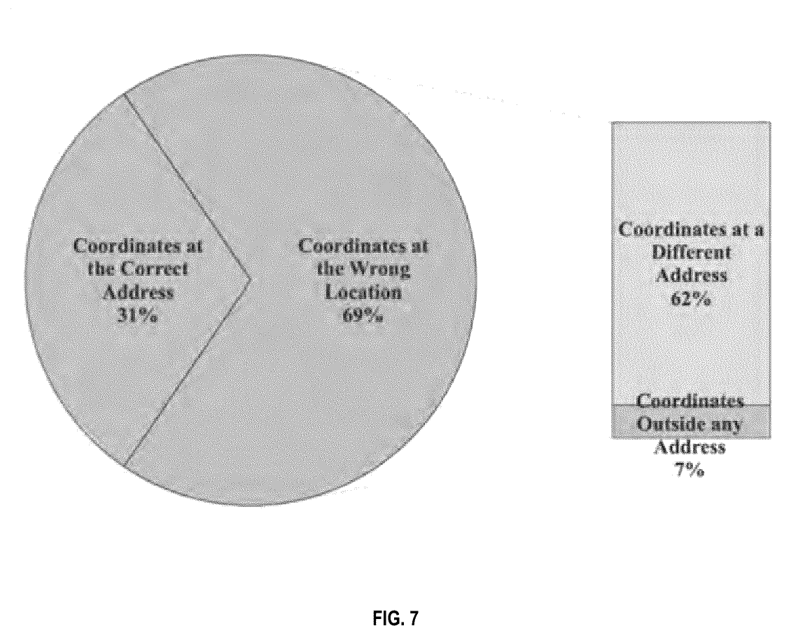

To highlight the GIS coordinates errors in the utility database, an analysis of the coordinates of the loads and their location in terms of the parcel they belong to was conducted. FIG. 7 shows that only the 31% of the loads have their coordinates inside the delimitation of the parcel they belong to. On the other hand, 69% of the loads are located at the wrong location. The loads that have their coordinates at the wrong location are separated into two groups: loads that belong to a different address constitutes 62% of the error, and loads with their coordinates outside any parcel with an address, e.g., in the street, represent the remaining 7%.

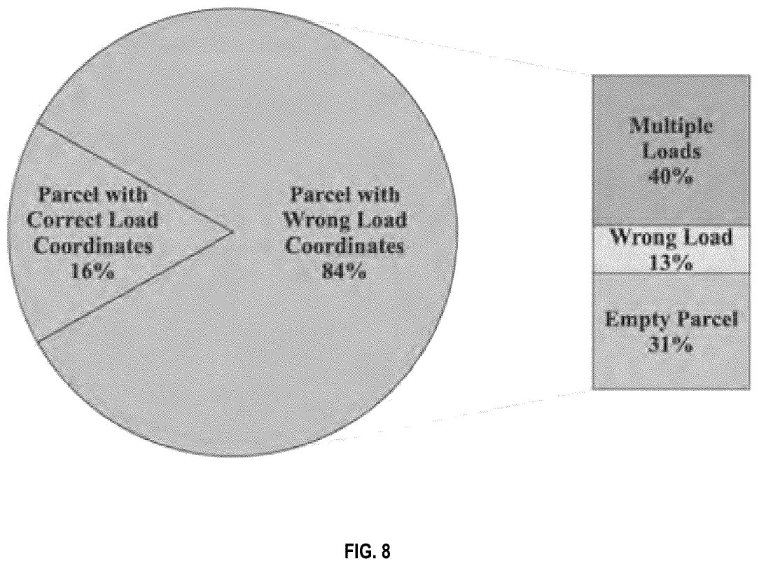

To further extend the analysis of the GIS coordinates errors in the utility database, a similar analysis is conducted for the parcels in the feeder. FIG. 8 shows that only 16% of the parcels in the feeder have the correct load coordinates. On the other hand, 84% of the parcels have the wrong load coordinates. These parcels are then separated into three groups: parcels with multiple loads constitutes 40% of this error, parcels with the wrong load constitutes another 13% of this error, and parcels with no loads constitutes the remaining 31% of this error.

### 5. Validation

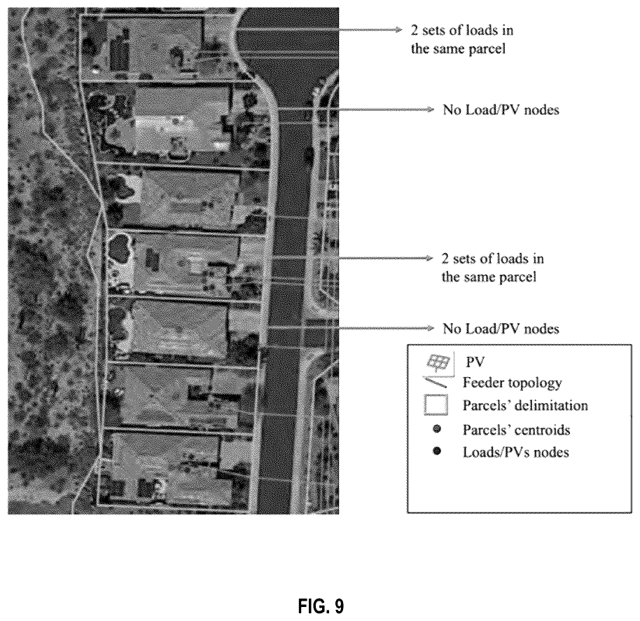

To illustrate the performance of the system, a section of the feeder is selected for analysis. FIG. 9 shows the coordinates of the parcels' centroid and the load/PV nodes for a section of the feeder. In this figure, some of the data errors recognized are highlighted to better analyze the performance of the proposed method and how it sorts out these type of errors.

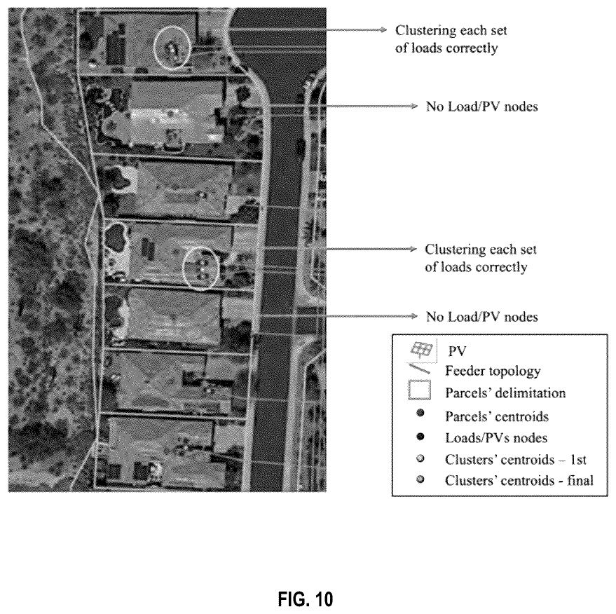

FIG. 10 shows the preliminary results and the final results of implementing the nested DBSCAN method proposed. In the yellow circles, it is observed how with the first DBSCAN (yellow dots) some clusters are wrongly merged into one cluster. Then, after the second DBSCANs are implemented (cyan dots), these clusters are divided into two or more clusters as expected. In the top yellow circle, the two resulting clusters correspond to a cluster of a load plus a DER (two points) and a cluster of a single load (one point). Similarly, in the second yellow circle, the two resulting clusters are two point clusters (load plus DER).

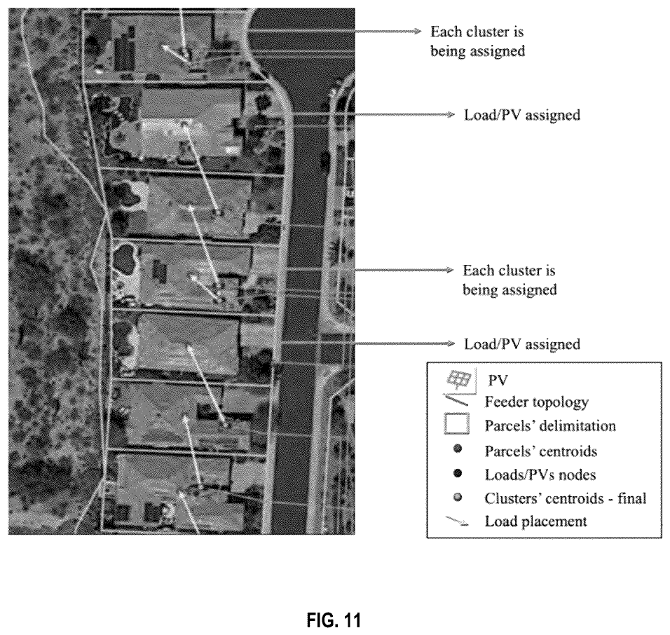

FIG. 11 shows the results of the optimization method by plotting the corrected coordinates for the same section of the feeder. The yellow arrows connect the clusters' centroids to the parcels according to the optimization results taking care of the problems highlighted in FIG. 9. As a result, all the parcels now have a cluster assigned.

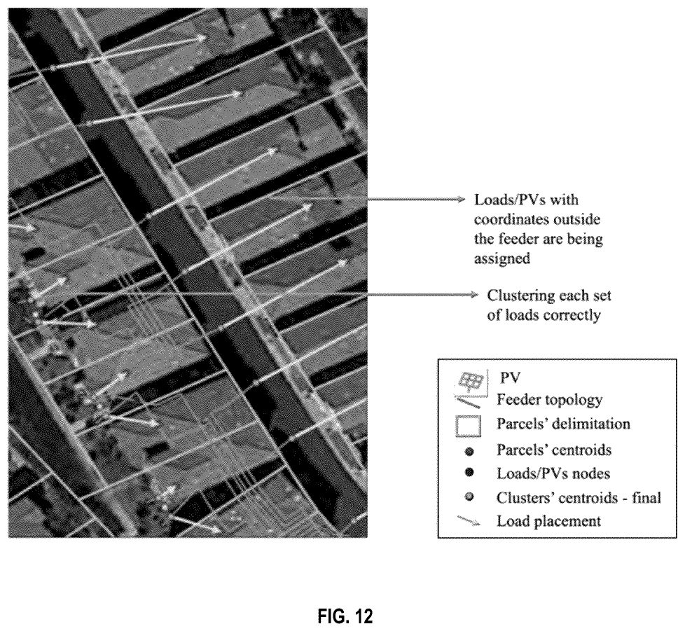

To further highlight the results of the system and associated methods discloses herein, some of the problems that are solved are shown in the following examples. FIG. 12 shows a common problem that many utilities have with some of their loads/PVs coordinates. It can be seen how the nodes were previously placed on the streets when the GIS database was constructed. In particular, the original measurements were taken by workers who drove by the parcel and captured coordinates that corresponded with the location of their vehicle, which was often positioned on the opposite side of the street from the parcel they are actually supposed to represent. After using the method outlined, the nodes are successfully moved to their corresponding premises as indicated by the arrows.

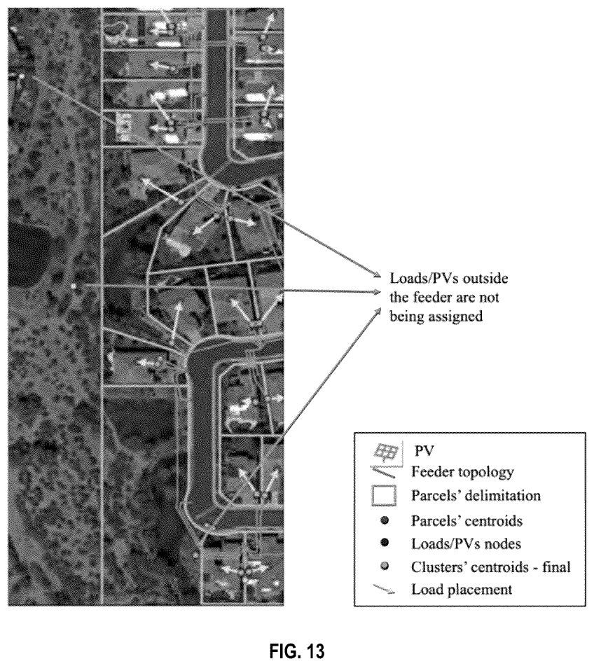

Similarly, FIG. 13 shows how the method is able to filter out some of the loads that do not belong to the customers of the feeder either because they do not belong to the feeder or because they are other type of loads (e.g. street lights, water pumps, and other similar non residential loads.).

The present methods provide a more accurate secondary network topology after correcting the loads/DERs to a more precise location.

To validate the output of the system, the physical address of all the loads in the feeder are retrieved from the parcel GIS delimitation data using the corrected coordinates, and then are compared against the physical address corresponding to each load in the utility secondary feeder topology database

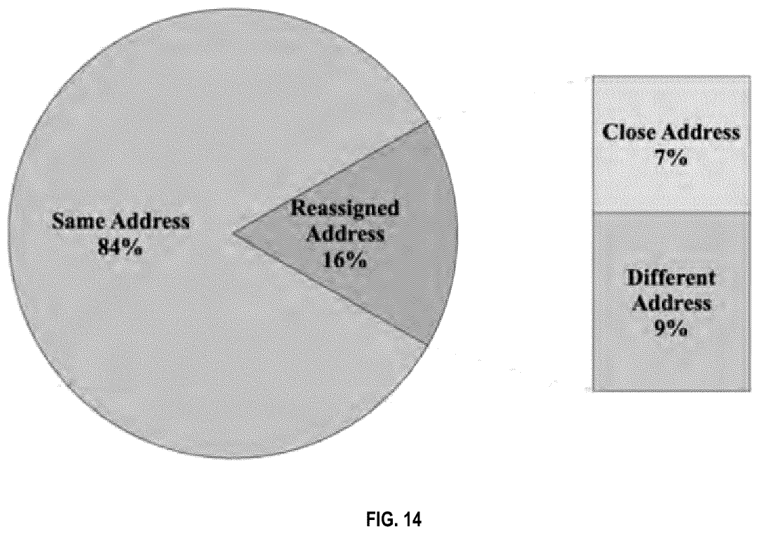

FIG. 14 shows the comparison between the physical address corresponding to the corrected GIS coordinates obtained from the system and the physical address from the utility's database. The comparison is divided in two main groups: loads with the same physical address as the one assigned by the utility, and loads with reassigned address, that is loads with different physical addresses than the one assigned by the utility. FIG. 14 shows that 84% of the loads retain their physical address after the system corrects their coordinates. On the other hand, only 16% of the loads are being assigned a new address by the tool. To better analyze the output of the system, the loads that are being reassigned to a different physical address are divided into two groups:
Close Address: close location from the one assigned by the utility (e.g., house next door, house in front).
Different Address: different location from the one assigned by the utility.

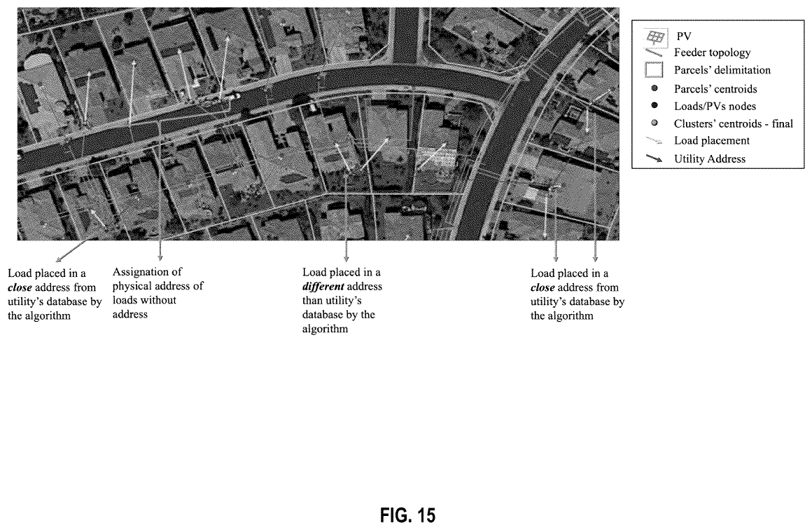

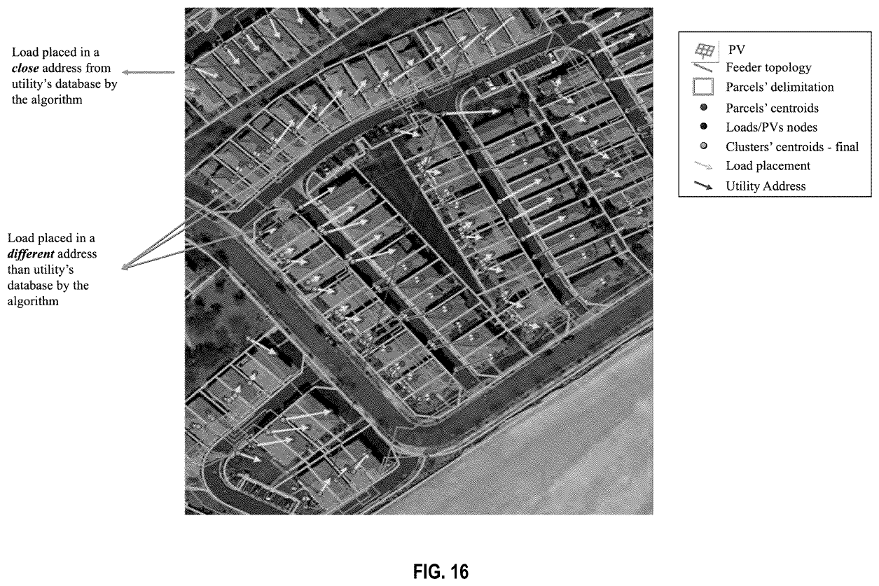

FIG. 15 and FIG. 16 show two cases that illustrates how the coordinates' correction and validation is carried out. The yellow arrows connect the clusters' centroids to the parcels according to the optimization results, while the red arrows connect the loads to the parcels according to the utility's database.

In both cases, it is evident how those loads located at a different address by the system are being placed in parcels closer to their initial coordinates, eliminating this type of error from the utility's database. In FIG. 15 a load was previously located across the street from its initial coordinates by the utility even though its initial coordinates were inside a parcel of the feeder. Then, this load was assigned to the closest parcel by the optimization method. A similar situation is shown for three loads in FIG. 16. Similarly, the loads that are listed as close address by the system are being placed at parcels closer to where they previously had their coordinates. In FIG. 16 a common data error is illustrated. It is shown that the loads placed at an address close to the one in the utility's database by the method correspond in majority of cases to loads in the same block that are shifted one parcel from their original coordinates. Additionally, the system takes care of the loads with no physical address in the utility's database and places them at an appropriate parcel as shown in FIG. 15, where loads that had their initial coordinates in the street and were not previously assigned to a parcel are now being assigned by the optimization method.

It should be understood from the foregoing that, while particular embodiments have been illustrated and described, various modifications can be made thereto without departing from the spirit and scope of the invention as will be apparent to those skilled in the art. Such changes and modifications are within the scope and teachings of this invention as defined in the claims appended hereto.

What is claimed is:

1. A method, comprising:
generating a plurality of polygons, each polygon of the plurality of polygons representing a parcel of a plurality of parcels represented within a set of municipal parcel geographic information system delimitation data and a set of utility secondary feeder topology data of a feeder;
determining, by application of a density-based spatial clustering of applications with noise (DBSCAN) method, a plurality of clusters, each cluster of the plurality of clusters corresponding to one or more nodes that correspond to a common customer represented within the set of municipal parcel geographic information system delimitation data and the set of utility secondary feeder topology data, each node of the one or more nodes including a load node or a distributed energy resource node; and
assigning each cluster of the plurality of clusters to a respective parcel of the plurality of parcels, each respective parcel having a physical address representing a geographic location indicated within the set of municipal parcel geographic information system delimitation data.

2. The method of claim 1, further comprising:
generating a plurality of shapefiles based on the set of municipal parcel geographic information system delimitation data and the set of utility secondary feeder topology data;
extracting geometry information from the plurality of shapefiles, the geometry information including coordinates associated with each element of a plurality of elements of the set of municipal parcel geographic information system delimitation data and the set of utility secondary feeder topology data; and
determining, based on the geometry information, a polygon centroid of each respective polygon of the plurality of polygons.

3. The method of claim 2, further comprising:
clustering, by the DBSCAN method, one or more points within the plurality of shapefiles that are density-reachable from an arbitrary point, the one or more points representing the one or more nodes.

4. The method of claim 1, wherein the DBSCAN method includes a first DBSCAN instance that determines a set of coordinates for each cluster of the plurality of clusters such that each cluster includes at least one node per cluster.

5. The method of claim 4, wherein the DBSCAN method includes a second DBSCAN instance that determines a set of coordinates for one or more new clusters of the plurality of clusters that include a plurality of nodes per cluster.

6. The method of claim 1, further comprising:
plotting correction of coordinates for a node of the one or more nodes.

7. The method of claim 1, further comprising:
associating each cluster with a polygon of the plurality of polygons such that a sum of distances between a cluster centroid of each respective cluster and a polygon centroid of a polygon associated with the cluster is minimized, and a quantity of clusters assigned to the plurality of polygons is maximized; and
correcting a set of coordinates associated with one or more nodes that correspond to a common customer based on the corresponding geographic location.

8. The method of claim 7, further comprising:
determining whether a load node of a cluster is to be associated with the polygon based on comparison between a maximum distance value and a distance from the load node to a polygon centroid of the polygon.

9. The method of claim 7, further comprising:
determining whether the polygon is to be associated with the feeder based on comparison between a maximum distance value and a plurality of distances from the polygon to each respective cluster of the plurality of clusters.

10. The method of claim 7, further comprising:
determining whether the polygon is to be associated with the cluster based on comparison between a maximum distance value and a distance from the polygon to the cluster.

11. The method of claim 1, further comprising:
generating a comma-separated value file including a physical address associated with each respective cluster of the plurality of clusters and coordinates representing locations of the one or more nodes.

12. A system, comprising:
a processor in communication with a memory and including instructions executable by the processor to:
generate a plurality of polygons, each polygon of the plurality of polygons representing a parcel of a plurality of parcels represented within a set of municipal parcel geographic information system delimitation data and a set of utility secondary feeder topology data of a feeder;
determine, by application of a density-based spatial clustering of applications with noise (DBSCAN) method, a plurality of clusters, each cluster of the plurality of clusters corresponding to one or more nodes that correspond to a common customer represented within the set of municipal parcel geographic information system delimitation data and the set of utility secondary feeder topology data, each node of the one or more nodes including a load node or a distributed energy resource node; and
assign each cluster of the plurality of clusters to a respective parcel of the plurality of parcels, each respective parcel having a physical address representing a geographic location indicated within the set of municipal parcel geographic information system delimitation data.

13. The system of claim 12, the memory including instructions further executable by the processor to:
generate a plurality of shapefiles based on the set of municipal parcel geographic information system delimitation data and the set of utility secondary feeder topology data;
extract geometry information from the plurality of shapefiles, the geometry information including coordinates associated with each element of a plurality of elements of the set of municipal parcel geographic information system delimitation data and the set of utility secondary feeder topology data; and
determine, based on the geometry information, a polygon centroid of each respective polygon of the plurality of polygons.

14. The system of claim 13, the memory including instructions further executable by the processor to:
cluster, by the DBSCAN method, one or more points within the plurality of shapefiles that are density-reachable from an arbitrary point, the one or more points representing the one or more nodes.

15. The system of claim 12, wherein the DBSCAN method includes:
a first DBSCAN instance that determines a set of coordinates for each cluster of the plurality of clusters such that each cluster includes at least one node per cluster; and
a second DBSCAN instance that determines a set of coordinates for one or more new clusters of the plurality of clusters that include a plurality of nodes per cluster.

16. The system of claim 12, the memory including instructions further executable by the processor to:
associate each cluster with a polygon of the plurality of polygons such that a sum of distances between a cluster centroid of each respective cluster and a polygon centroid of a polygon associated with the cluster is minimized, and a quantity of clusters assigned to the plurality of polygons is maximized; and
correct a set of coordinates associated with one or more nodes that correspond to a common customer based on the corresponding geographic location.

17. The system of claim 16, the memory including instructions further executable by the processor to:
determine whether a load node of a cluster is to be associated with the polygon based on comparison between a maximum distance value and a distance from the load node to a polygon centroid of the polygon.

18. The system of claim 16, the memory including instructions further executable by the processor to:
determine whether the polygon is to be associated with the feeder based on comparison between a maximum distance value and a plurality of distances from the polygon to each respective cluster of the plurality of clusters.

19. The system of claim 16, the memory including instructions further executable by the processor to:
determine whether the polygon is to be associated with the cluster based on comparison between a maximum distance value and a distance from the polygon to the cluster.

20. The system of claim 12, the memory including instructions further executable by the processor to:
generate a comma-separated value file including a physical address associated with each respective cluster of the plurality of clusters and coordinates representing locations of the one or more nodes.
